(19) United States
(12) Patent Application Publication
(10) Pub. No.: US 2026/0094541 A1
(43) Pub. Date: Apr. 2, 2026

(54) STOREFRONT ADVERTISEMENT BODY

(71) Applicant: Bandai Co., Ltd., Tokyo (JP)

(72) Inventor: Hidetsugu Watanabe, Tokyo (JP)

(21) Appl. No.: 19/339,376

(22) Filed: Sep. 25, 2025

(30) Foreign Application Priority Data
Sep. 30, 2024 (JP) 2024-170967

(51) Int. Cl. G09F 1/06; A47F 5/11

(52) U.S. Cl. CPC G09F 1/06; A47F 5/114

(57) ABSTRACT

The storefront advertisement body includes: a main body portion that is deformable from a first mode to a second mode and includes a storage portion, and the storage portion does not function as the storage portion in the first mode and functions as the storage portion in the second mode. In the main body portion of the storefront advertisement body in the first mode, since a part of the main body portion is provided with the storage portion formed of a cut portion and a bent portion, the storage portion is not three-dimensionally configured, so it is convenient to store and transport the main body portion. In addition, the substantially box-shaped storage portion can be easily configured by the cut portion and the bent portion.

### CROSS REFERENCE TO RELATED APPLICATIONS

This application claims priority to and the benefit of Japanese Application No. 2024-170967, filed Sep. 30, 2024, the content of which is hereby incorporated by reference in its entirety.

### BACKGROUND

### 1. Technical Field

The present disclosure relates to a storefront advertisement body.

### 2. Description of the Related Art

Conventionally, as a storefront advertisement body, for example, Utility Model Registration No. 3130015 discloses a configuration including a flat case portion that can be assembled into a rectangular tube shape and can be a support, a three-folded front surface panel that is attached to a part of a bottom plate portion of the case at a center portion thereof and can stand on a front surface side of the support, a bottom plate panel that is attached to be connected to a lower end of the front surface panel and serves as a pedestal, a back surface panel that is attached to the bottom plate panel and can stand on a back surface side of the support and can be folded, and a fixing panel that is attached to a back side of the back surface panel to fix the raised back surface panel to the support, in which the four panels are packaged by the case portion in a state where the front surface panel is folded in three and the back surface panel is folded at a plurality of places together with the fixing panel.

In Utility Model Registration No. 3130015, a box-shaped storefront advertisement body of an assembly type can simply draw a character or the like on a box-shaped front surface panel, and thus has a problem in usability.

An object of an embodiment of the present disclosure is to provide a convenient storefront advertisement body.

### BRIEF SUMMARY

A storefront advertisement body according to one aspect of the present disclosure includes: a main body portion that is deformable from a first mode to a second mode and includes a storage portion, and the storage portion does not function as the storage portion in the first mode and functions as the storage portion in the second mode.

According to the present disclosure, it is possible to provide a storefront advertisement body having a high degree of attention.

### BRIEF DESCRIPTION OF THE FIGURES

FIG. 1 is a perspective view of a storefront advertisement body according to one aspect of the present disclosure;

FIG. 2 is a plan view illustrating a first mode of a main body portion in a storefront advertisement body illustrated in FIG. 1;

FIG. 3 is an enlarged perspective view of a region E in FIG. 2;

FIG. 4 is a perspective view illustrating an initial state of an operation at the time of assembling a storage portion;

FIG. 5 is a perspective view illustrating a state in which the storage portion is assembled;

FIG. 6 is a perspective view illustrating a state in which a bundle of lottery tickets is inserted into the storage portion;

FIG. 7 is a perspective view illustrating a state in which a bundle of lottery tickets is stored in the storage portion;

FIG. 8 is a perspective view of a state in which the bundle of lottery tickets is stored in the storage portion when viewed from a back side of the main body portion; and

FIG. 9 is a cross-sectional view of a portion taken along line A-A in FIG. 8.

### DETAILED DESCRIPTION OF VARIOUS EMBODIMENTS

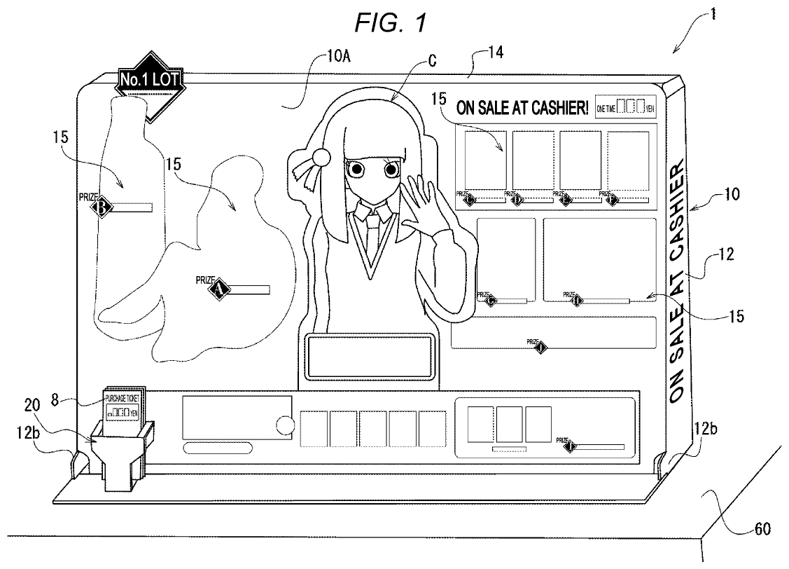

Hereinafter, an aspect of a storefront advertisement body representing one side of the present disclosure will be described with reference to the drawings. FIG. 1 is a perspective view of one aspect of a storefront advertisement body 1.

The storefront advertisement body 1 illustrated in FIG. 1 is formed of, for example, thick paper, cardboard, or the like, and is formed so as to be able to be displayed at the storefront in order to sell and promote a lottery ticket 8 of a product of a predetermined character C or a character related product. In a state of being used at the storefront, a main body portion 10 has a three-dimensional mode as illustrated in FIG. 1, and a lower end portion 11 constituting the bottom surface can be placed and displayed on a placement portion 60 at an appropriate position of the storefront so that one surface side which is a front surface 10s is shown to the customer. As will be described later, the storefront advertisement body 1 can be modified into the main body portion 10 that can be modified from a flat plate-shaped first mode to a three-dimensional second mode at the time of use, and similarly from the flat plate-shaped first mode to the three-dimensional second mode.

Note that the advertisement body that sells the lottery ticket 8 in which the character C is appropriately provided is in a substantially central portion of a center plate surface 10A of the main body portion 10. For example, a storage portion 20 capable of storing the lottery ticket 8 is provided on the lower left side of the front surface of the main body portion 10, and the lottery ticket 8 is stored in the storage portion 20. In addition, for a product that is won by purchasing the lottery ticket 8, for example, prize A to prize J are posted by a product information unit 15 posted around the character C.

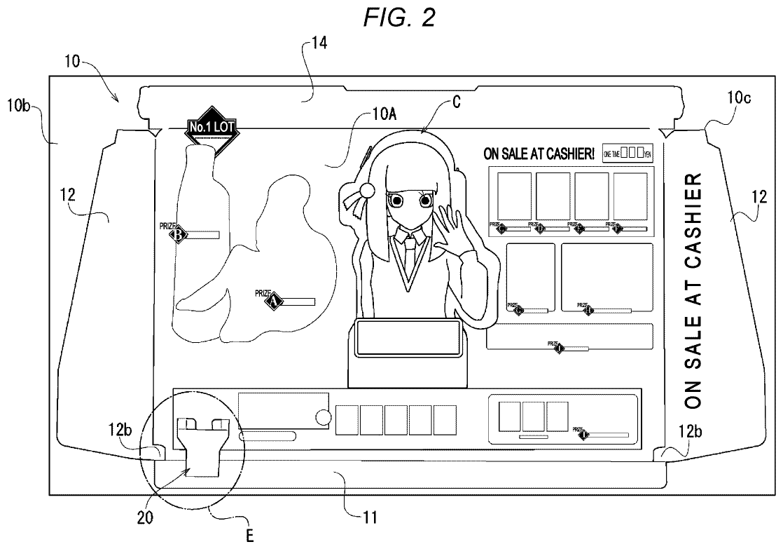

FIG. 2 is a plan view illustrating a first mode of the main body portion 10 in the storefront advertisement body 1 illustrated in FIG. 1.

As illustrated in FIG. 2, the main body portion 10 in a state before being assembled into a three-dimensional shape has a configuration in which a predetermined shape can be cut out into a rectangular sheet body 10b via a cut-out line 10c. The main body portion 10 includes four pieces of upper, lower, left, and right sides of the lower end portion 11 constituting a bottom surface, an upper surface portion 14 on an upper side, and left and right side surface portions 12 around the rectangular center plate surface 10A. That is, the bent portion of the outer periphery of the center plate surface 10A is bent back and forth. For example, the lower end portion 11 is bent forward, and the left and right both side surface portions 12 and the upper surface portion 14 are bent backward. For example, when the left and right both side surface portions 12 are bent by side surface notches 12c at the lower end portion, a front protruding portion 12b (see FIG. 1) protrudes forward and constitutes a support portion of the bottom portion together with the lower end portion 11. In addition, by appropriately engaging and locking the left and right end portions of the upper surface portion 14 and the upper end portions of the side surface portions 12, the storefront advertisement body 1 is three-dimensionally assembled and brought into an upright state. Note that, since the side surface portions 12 are viewed from the side surface direction in a state in which the main body portion 10 is placed at the storefront, appropriate words and patterns that perform the POP function are described.

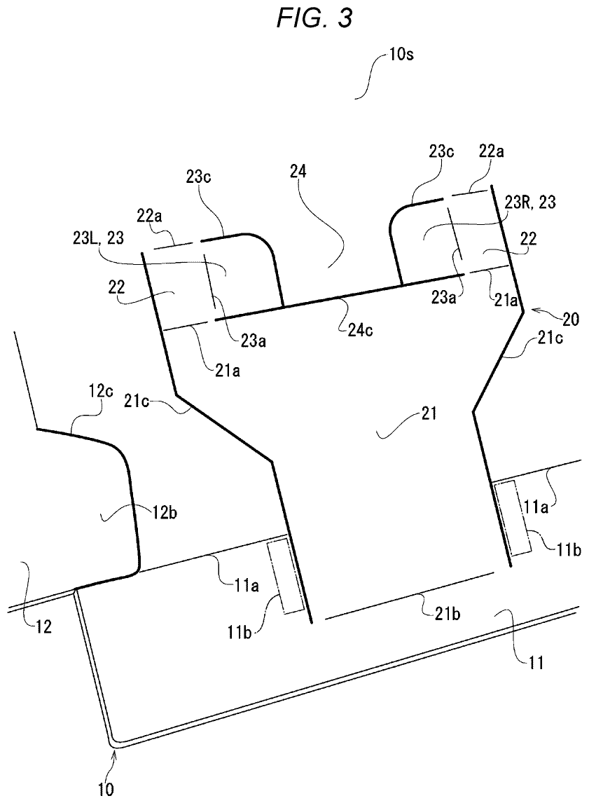

FIG. 3 is an enlarged perspective view of a region E in FIG. 2.

As illustrated in FIG. 3, in the first mode, the storage portion 20 includes a left and right cut portion 21c, an upper end cut portion 23c, and an insertion port cut portion 24c which are cut portions of the main body portion 10, and a bottom surface bent portion 11a, a front surface wall upper bent portion 21a, a front surface wall lower bent portion 21b, an upper end bent portion 22a, and an auxiliary portion bent portion 23a. Both the left and right cut portions 21c are bent so as to narrow the interval from the upper end bent portion 22a toward the front surface wall lower bent portion 21b so as to constitute a front surface wall 21 and a left and right upper surface walls 22 of the storage portion 20. In addition, the left and right cut portion 21c extends in a direction orthogonal to the bottom surface bent portion 11a. In addition, the front surface wall upper bent portion 21a, front surface wall lower bent portion 21b, and upper end bent portion 22a are provided so as to be parallel to the bottom surface bent portion 11a. Further, the bottom surface bent portion 11a is positioned between the front surface wall lower bent portion 21b and the front surface wall upper bent portion 21a.

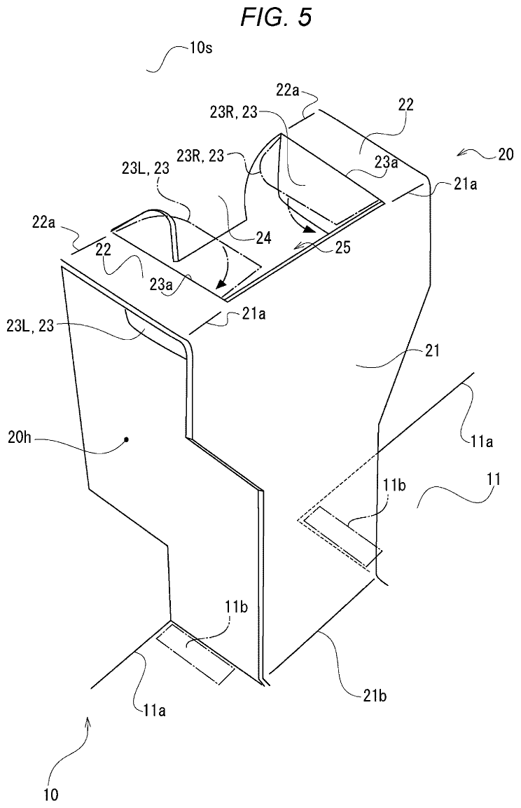

The insertion port cut portion 24c constituting an insertion port 25 (see FIG. 5) is formed to be aligned in a straight line with the front surface wall upper bent portion 21a between the two front surface wall upper bent portions 21a. In addition, two upper end cut portions 23c are formed on the upper end side of the storage portion so as to constitute both left and right end edges of the insertion port 25. Then, the upper end cut portion 23c includes a straight line portion aligned in a straight line with the upper end bent portion 22a and a straight line portion extending parallel to the left and right cut portion 21c and continuing to an insertion port cut portion 24c. In addition, the auxiliary portion bent portion 23a forming an auxiliary portion 23 is provided between both end portions of the insertion port cut portion 24c and an end portion of the upper end cut portion 23c.

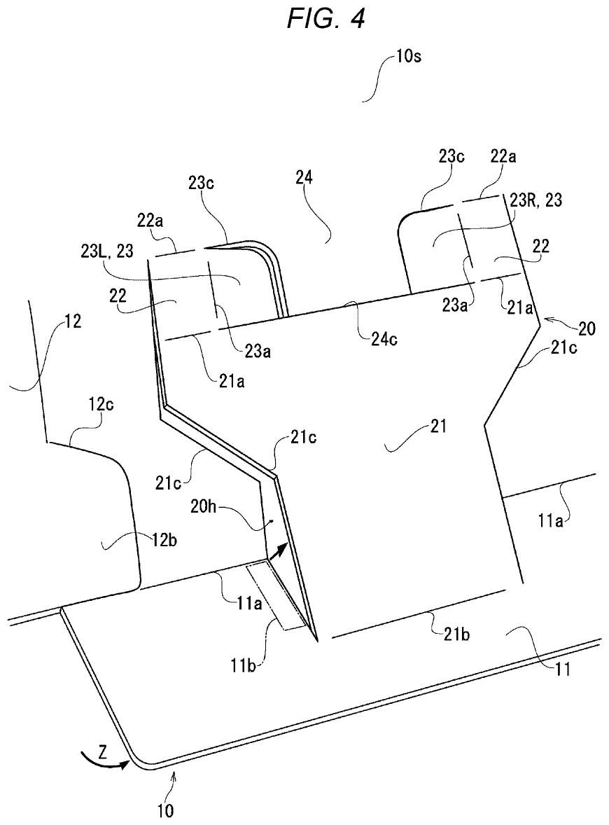

FIG. 4 is a perspective view illustrating an initial state of an operation at the time of assembling the storage portion 20.

When assembling the storefront advertisement body 1, first, the main body portion 10 is cut out by the cut-out line 10c of the sheet body 10b. Thereafter, the cut-out main body portion 10 of the first mode is assembled into the three-dimensional second state illustrated in FIG. 1. At the time of this assembly, as illustrated in FIG. 4, the lower end portion 11 is bent so as to protrude forward (in a direction of an arrow Z in the drawing) from a position of the bottom surface bent portion 11a as a starting point. In the initial stage of the bending operation, as illustrated in the drawing, the upper end bent portion 22a and the front surface wall lower bent portion 21b are bent. That is, the left and right cut portion 21c are separated, and an opening portion 20h starts to be formed. Then, as the bending angle of the bottom surface bent portion 11a approaches 90 degrees, the front surface wall upper bent portion 21a is bent so as to protrude forward. Then, in the bending operation, the front surface wall upper bent portion 21a is bent to 90 degrees, and the front surface wall 21 is bent so as to be parallel to the front surface 10s and the upper surface wall 22 is bent so as to be parallel to the lower end portion 11.

As described above, the storage portion 20 of the storefront advertisement body 1 is formed so as to protrude to the lower end portion 11 of the main body portion 10 on the front surface 10s in the second mode. Here, in the upright state of the storefront advertisement body 1, the lower end portion 11 and the center plate surface 10A are connected to each other by a tension structure. Thus, the storage portion 20 can reinforce the three-dimensional shape of the main body portion 10 to assist the upright state.

FIG. 5 is a perspective view illustrating a state in which the storage portion 20 is assembled.

In the state illustrated in FIG. 5, the lower end portion 11 of the storage portion 20 is bent forward at 90 degrees with respect to the front surface 10s. As a result, as described above, the storage portion 20 is configured in a state where the front surface wall upper bent portion 21a is bent at 90 degrees, that is, in a state in which the front surface wall 21 and the left and right upper surface walls 22 are bent at a right angle toward the front. In addition, the left and right tongue-shaped auxiliary portions 23 (a first auxiliary portion 23R on right side and a second auxiliary portion 23L on left side) are connected to the left and right upper surface walls 22 via an auxiliary portion bent portions 23a. The auxiliary portion 23 initially constitutes the same surface as the left and right upper surface walls 22. Then, the auxiliary portion bent portions 23a are bent inward (downward) to form the rectangular insertion port 25 into which the lottery ticket 8 is inserted.

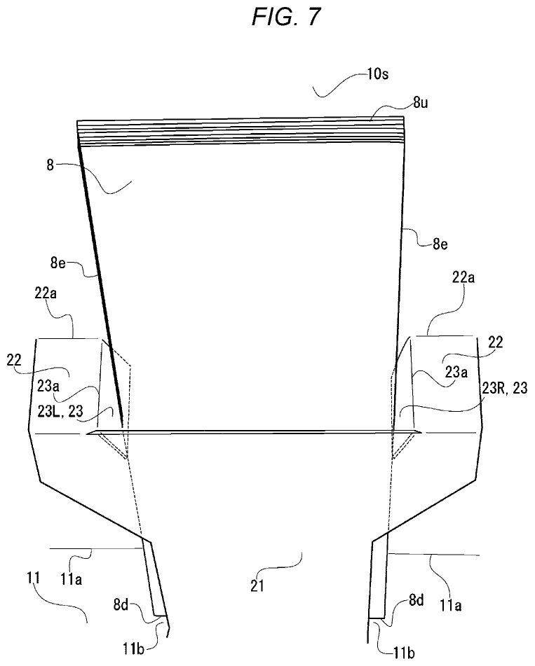

As will be described later, the lower end edge 8d (see FIG. 7) of the lottery ticket 8 inserted through the insertion port 25 is held by a lower end support portion 11b formed as a first support portion of the lower end portion 11. Further, the back surface side of the lottery ticket 8 is supported by a rear surface support portion 24 provided as a second support portion orthogonal to the lower end support portion 11b on the front surface 10s side of the insertion port 25.

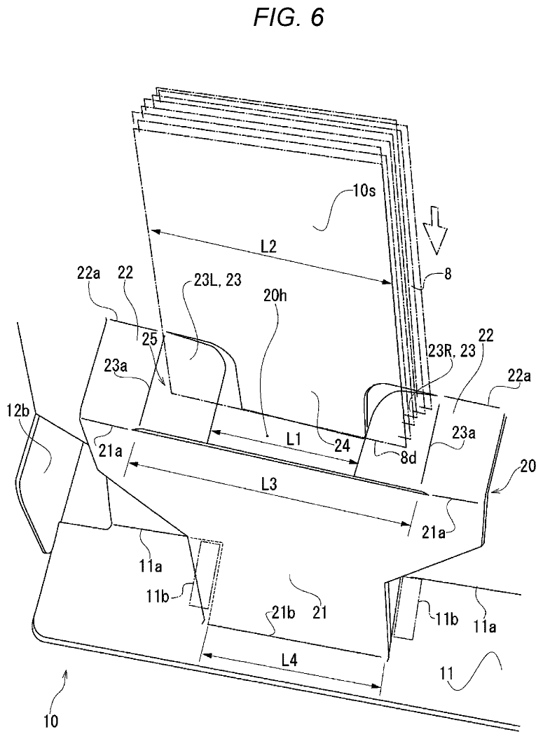

FIG. 6 is a perspective view illustrating a state in which a bundle of the lottery tickets 8 is inserted into the storage portion 20. FIG. 7 is a perspective view illustrating a state in which a bundle of lottery tickets 8 is stored in the storage portion 20.

When the lottery tickets 8 are stored in the assembled storage portion 20, for example, as illustrated in FIG. 6, a bundle of the lottery tickets 8 is inserted into the insertion port 25. At this time, an interval (L1) between the first auxiliary portion 23R and the second auxiliary portion 23L is configured to be smaller than a width dimension (L2) of the lottery ticket 8. However, the first auxiliary portion 23R and the second auxiliary portion 23L are elastically deformed to allow the insertion of the lottery ticket 8, and a bundle of the lottery tickets 8 is stored in the storage portion 20 as illustrated in FIG. 7. In addition, the left and right cut portions 21c are configured such that an interval (L4) between the lower end support portions 11b is smaller than a left and right interval (L3) of the insertion port 25 so that the lower end support portion 11b can support the lower end edge 8d of the lottery ticket 8.

As illustrated in FIG. 7, left and right end portions 8e, which are one end portion and the other end portion in the width direction, of the lottery ticket 8 are sandwiched from the left and right direction by the first auxiliary portion 23R and the second auxiliary portion 23L. That is, since the initial interval (L1) between the first auxiliary portion 23R and the second auxiliary portion 23L is configured to be narrower than the width (L2) of the lottery ticket, the lottery ticket 8 is pushed and held from the left and right direction by the first auxiliary portion 23R and the second auxiliary portion 23L in the inserted state. As a result, for example, even in a state in which the left and right end portions 8e of the lottery ticket 8 are not aligned as illustrated in FIG. 6, the lottery ticket 8 is appropriately pushed and positioned in the left and right horizontal direction, and is stored in a clean state in which the end portions 8e are aligned. In addition, in the second mode, in the storage portion 20, the lottery ticket 8 is stored in a state where its lower end edge 8d is supported by the lower end support portions 11b provided on the left and right of the lower end side of the opening portion 20h and an upper end portion 8u is aligned.

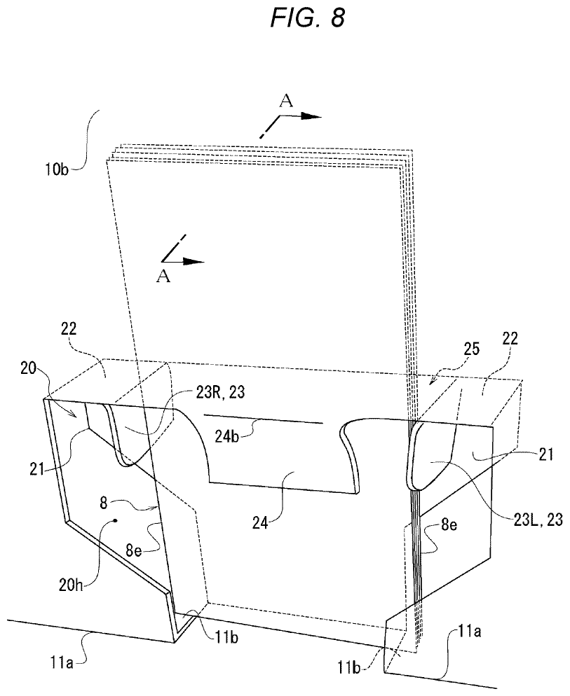

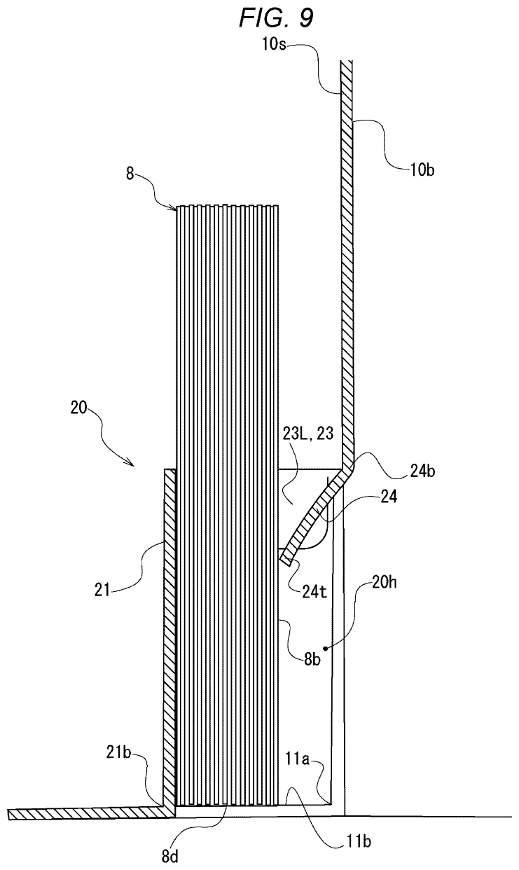

FIG. 8 is a perspective view of a state in which the bundle of lottery tickets 8 is stored in the storage portion 20 when viewed from a back side of the main body portion 10. FIG. 9 is a cross-sectional view of a portion taken along line A-A in FIG. 8. In the mode illustrated in FIGS. 8 and 9, the configuration of the rear surface support portion 24 is different from the shape illustrated in FIG. 6.

In the second mode, as illustrated in FIGS. 8 and 9, the storage portion 20 has a configuration in which the rear surface support portion 24 that supports a back surface portion 8b, which is a back surface portion of the stored lottery ticket 8, is bent forward. That is, for example, the rear surface support portion 24 is appropriately bent forward with a rear bent portion 24a on the protruding proximal end side as a starting point. Since the rear surface support portion 24 protrudes forward, the back surface portion 8b of the lottery ticket 8 can be configured so that, for example, a tip end portion 24t is pressed toward the front side, and the bundle of the lottery ticket 8 can be pressed so as not to vary. In particular, even in a case where the number of the lottery tickets 8 is reduced, the lottery tickets 8 can be firmly held. In addition, as described above, the bundle of the lottery tickets 8 is stored in a state where the front, rear, left, and right directions are neatly aligned by being pressed in the left and right direction by the auxiliary portion 23.

As described above, in the first mode of the storefront advertisement body 1 of the present aspect, since a part of the main body portion 10 is provided with the storage portion 20 formed of the cut portion (21c, 23c, and 24c) and the bent portion (11a, 21a, 22a, and 21b), the storage portion 20 is not three-dimensionally configured, so that a small volume can be obtained and it is convenient to store and transport the storefront advertisement body 1. In addition, in the main body portion 10 (the second mode) deformed into the three-dimensional shape, it is possible to easily form a portion of the cutout portion and the bent portion from the front surface 10s of one surface of the main body portion 10 by the cutout portion and the bent portion. Furthermore, since the storage portion 20 is formed integrally with the main body portion 10, detachment from the main body portion 20 and loss thereof can be prevented.

In addition, in the storefront advertisement body 1 of the present aspect, since the bent portion and the cut portion constituting the storage portion 20 are provided adjacent to each other, the storage portion 20 can easily form the three-dimensional shape only by the bent portion bending operation.

In addition, in the storefront advertisement body 1 of the present aspect, since the storage portion 20 is configured to be able to store the lottery ticket 8, the storefront advertisement body 1 can be used as an advertisement body for sale of the lottery ticket 8 and a storage tool of the lottery ticket 8.

In the storefront advertisement body 1 of the present aspect, since the main body portion 10 is configured to be able to take the upright state in the second mode, the main body portion 10 can stand by itself and exhibit. In addition, since the storage portion 20 has a structure projecting from the front surface 10s to the lower end portion 11 in the upright state, it is possible to provide a reinforcing/assisting function for maintaining the three-dimensional shape of the main body portion 10.

In addition, in the storefront advertisement body 1 of the present aspect, since the end portion 8e of the lottery ticket 8 can be pressed and sandwiched by the auxiliary portions 23 (the first auxiliary portion 23R and the second auxiliary portion 23L) provided in the insertion port 25 of the storage portion 20, the left and right end portions 8e of the plurality of lottery tickets 8 stored can be aligned, and the lottery tickets 8 can be neatly stored. In particular, since the auxiliary portion 23 is provided in the insertion port 25, the end portions 8e can be effectively aligned by the abutment of the auxiliary portion 23 when the lottery ticket 8 is inserted into the storage portion 20. In addition, since the inclination direction of the auxiliary portion 23 is the inward and downward inclination of the storage portion 20, the operation at the time of insertion is easy.

In the storefront advertisement body 1 of the present aspect, in the left and right cut portion 21c of the main body portion 10, the interval (L4) between the lower end support portions 11b is configured to be smaller than the left and right interval (L3) of the insertion port 25 so that the lower end support portions 11b (first support portions) can support the lower end edge 8d of the lottery ticket 8. As a result, it is possible to form the lower end support portion 11b capable of holding the lottery ticket 8 only by three-dimensionally assembling the main body portion 10.

In the storefront advertisement body 1 of the present aspect, since the rear surface support portion 24 capable of supporting the back surface portion 8b of the stored lottery ticket 8 is provided, it is possible to press the plurality of stored lottery tickets 8 in the thickness direction. As a result, the plurality of lottery tickets 8 can be neatly stored in close contact with each other, and particularly when the number of the lottery tickets 8 decreases, it is possible to align the plurality of lottery tickets 8 while suppressing variations in the thickness direction of the lottery tickets 8.

Although the aspects of the present disclosure have been described above, the present disclosure can be appropriately modified within the scope of the technical idea. For example, in the above aspect, the shape of the storefront advertisement body 1 is substantially rectangular, but the present disclosure is not necessarily limited thereto. In addition, in the above aspect, one storage portion 20 is provided, but a plurality of storage portions 20 may be provided.

As described above, the following matters are described in the present specification.
(1)

A storefront advertisement body including:
a main body portion that is deformable from a first mode to a second mode and includes a storage portion; and
the storage portion does not function as the storage portion in the first mode and functions as the storage portion in the second mode.
(2)

The storefront advertisement body according to (1), in which
the storage portion is configured to function as the storage portion only on one surface of the main body portion in the second mode.
(3)

The storefront advertisement body according to (1) or (2), in which
the storage portion is configured to be able to store a plurality of lottery tickets in the second mode.
(4)

The storefront advertisement body according to any one of (1) to (3), in which
the first mode is a flat plate form, and the second mode is a three-dimensional form.
(5)

The storefront advertisement body according to any one of (1) to (4), in which
the main body portion is configured to be in an upright state in the second mode.
(6)

The storefront advertisement body according to any one of (1) to (5), in which
the storage portion is configured to be able to assist the upright state of the main body portion in the second mode.
(7)

The storefront advertisement body according to any one of (1) to (6), in which
the main body portion integrally includes the storage portion and is configured to be non-detachable.
(8)

The storefront advertisement body according to any one of (1) to (7), in which
the main body portion is configured as one sheet body in the first mode.
(9)

The storefront advertisement body according to any one of (1) to (8), in which
the storage portion includes, in the second mode, an auxiliary portion that enables horizontal positioning of a lottery ticket stored.
(10)

The storefront advertisement body according to (9), in which
the auxiliary portion includes a first auxiliary portion and a second auxiliary portion, and
the first auxiliary portion and the second auxiliary portion are configured to be able to abut on the lottery ticket stored in the storage portion in the second mode.
(11)

The storefront advertisement body according to (10), in which
an insertion port is formed in the storage portion in the second mode, and
the first auxiliary portion and the second auxiliary portion are formed in the insertion port.
(12)

The storefront advertisement body according to (10) or (11), in which
the first auxiliary portion is configured to abut on one end portion of the lottery ticket stored in the storage portion in the second mode, and
the second auxiliary portion is configured to abut on an other end portion of the lottery ticket stored in the storage portion in the second mode.
(13)

The storefront advertisement body according to any one of (10) to (12), in which
the first auxiliary portion and the second auxiliary portion are configured to be able to sandwich the lottery ticket stored in the storage portion in the second mode.
(14)

The storefront advertisement body according to any one of (1) to (13), in which
the main body portion is configured to form an opening portion in the second mode.
(15)

The storefront advertisement body according to any one of (1) to (14), in which
the main body portion includes a cut portion in the first mode, and is configured to be separable at the cut portion in the second mode.
(16)

The storefront advertisement body according to (15), in which the main body portion includes a bent portion, and
the bent portion is provided adjacent to the cut portion.
(17)

The storefront advertisement body according to (16), in which
the storage portion is configured to function as the storage portion in the second mode on condition that the bent portion is bent.
(18)

The storefront advertisement body according to any one of (14) to (17), in which
the storage portion includes, in a lower portion of the storage portion in the second mode, a first support portion capable of supporting a lower end edge of a stored lottery ticket and the opening portion not supporting the lower end edge.
(19)

The storefront advertisement body according to (18), in which
an insertion port is formed in the storage portion in the second mode, and
the first support portions are provided to face positions sandwiching the opening portion, and an interval between the facing positions is configured to protrude to an inside of the insertion port when viewed from a side of the insertion port.
(20)

The storefront advertisement body according to (18) or (19), in which
the storage portion includes a second support portion capable of supporting a surface portion of the stored lottery ticket in the second mode.
(21)

The storefront advertisement body according to (20), in which
the first support portion and the second support portion are perpendicular to each other in the second mode.
(22)

The storefront advertisement body according to any one of (1) to (21), in which
the storage portion is configured to be formed at a lower end portion of the main body portion in the second mode.

What is claimed is:

1. A storefront advertisement body comprising:
a main body portion that is deformable from a first mode to a second mode and includes a storage portion; and
the storage portion does not function as the storage portion in the first mode and functions as the storage portion in the second mode.

2. The storefront advertisement body according to claim 1, wherein
the storage portion is configured to function as the storage portion only on one surface of the main body portion in the second mode.

3. The storefront advertisement body according to claim 1, wherein
the storage portion is configured to be able to store a plurality of lottery tickets in the second mode.

4. The storefront advertisement body according to claim 1, wherein
the first mode is a flat plate form, and the second mode is a three-dimensional form.

5. The storefront advertisement body according to claim 1, wherein
the main body portion is configured to be in an upright state in the second mode.

6. The storefront advertisement body according to claim 1, wherein
the storage portion is configured to be able to assist the upright state of the main body portion in the second mode.

7. The storefront advertisement body according to claim 1, wherein
the main body portion integrally includes the storage portion and is configured to be non-detachable.

8. The storefront advertisement body according to claim 1, wherein
the main body portion is configured as one sheet body in the first mode.

9. The storefront advertisement body according to claim 1, wherein
the storage portion includes, in the second mode, an auxiliary portion that enables horizontal positioning of a lottery ticket stored.

10. The storefront advertisement body according to claim 9, wherein
the auxiliary portion includes a first auxiliary portion and a second auxiliary portion, and
the first auxiliary portion and the second auxiliary portion are configured to be able to abut on the lottery ticket stored in the storage portion in the second mode.

11. The storefront advertisement body according to claim 10, wherein
an insertion port is formed in the storage portion in the second mode, and
the first auxiliary portion and the second auxiliary portion are formed in the insertion port.

12. The storefront advertisement body according to claim 10, wherein
the first auxiliary portion is configured to abut on one end portion of the lottery ticket stored in the storage portion in the second mode, and
the second auxiliary portion is configured to abut on an other end portion of the lottery ticket stored in the storage portion in the second mode.

13. The storefront advertisement body according to claim 10, wherein
the first auxiliary portion and the second auxiliary portion are configured to be able to sandwich the lottery ticket stored in the storage portion in the second mode.

14. The storefront advertisement body according to claim 1, wherein
the main body portion is configured to form an opening portion in the second mode.

15. The storefront advertisement body according to claim 1, wherein
the main body portion includes a cut portion in the first mode, and is configured to be separable at the cut portion in the second mode.

16. The storefront advertisement body according to claim 15, wherein the main body portion includes a bent portion, and
the bent portion is provided adjacent to the cut portion.

17. The storefront advertisement body according to claim 16, wherein
the storage portion is configured to function as the storage portion in the second mode on condition that the bent portion is bent.

18. The storefront advertisement body according to claim 14, wherein
the storage portion includes, in a lower portion of the storage portion in the second mode, a first support portion capable of supporting a lower end edge of a stored lottery ticket and the opening portion not supporting the lower end edge.

19. The storefront advertisement body according to claim 18, wherein
an insertion port is formed in the storage portion in the second mode, and
the first support portions are provided to face positions sandwiching the opening portion, and an interval between the facing positions is configured to protrude to an inside of the insertion port when viewed from a side of the insertion port.

20. The storefront advertisement body according to claim 18, wherein
the storage portion includes a second support portion capable of supporting a surface portion of the stored lottery ticket in the second mode.

21. The storefront advertisement body according to claim 20, wherein
the first support portion and the second support portion are perpendicular to each other in the second mode.

22. The storefront advertisement body according to claim 1, wherein
the storage portion is configured to be formed at a lower end portion of the main body portion in the second mode.
